(19) United States
(12) Patent Application Publication
(10) Pub. No.: US 2012/0041632 A1
(43) Pub. Date: Feb. 16, 2012

(54) COMBINED LANE CHANGE ASSIST AND REAR, CROSS-TRAFFIC ALERT FUNCTIONALITY

(75) Inventor: Maria Eugenia Garcia Bordes, Northville, MI (US)

(73) Assignee: ROBERT BOSCH GMBH, Stuttgart (DE)

(21) Appl. No.: 12/855,238

(22) Filed: Aug. 12, 2010

(51) Int. Cl. B60Q 9/00; G06F 7/00

(52) U.S. Cl. 701/29.1; 701/36; 340/435

(57) ABSTRACT

A system and method for detecting a potential threat to a vehicle. The system generates a warning to a driver of the vehicle of the potential threat. The system includes an object detection device, a controller, and a human-machine interface (HMI). The object detection device is configured to detect objects next to the vehicle, approaching the vehicle from a side, and approaching the vehicle from behind. The controller receives an indication of a detected object from the object detection device, and determines a position, a speed, an acceleration, and a direction of travel of the detected object. The controller then categorizes the detected object as a potential threat when at least one of (a) the vehicle is moving forward and the detected object is adjacent the vehicle, (b) the vehicle is moving forward at a first speed and the detected object is approaching the vehicle from behind at a second speed relative to the first speed that indicates a time to collision is less than a predetermined threshold, and (c) the vehicle is moving in reverse and the detected object is approaching the vehicle from the side, the detected object is within a first distance of the vehicle and is traveling within a speed range. The HMI is coupled to the controller and is configured to receive an indication of the potential threat from the controller and to provide the warning to the driver of the potential threat.

### BACKGROUND

The present invention relates to safety systems for vehicles. More specifically, the present invention relates to a safety system for alerting a driver of a potential hazard from another vehicle.

Some automobiles have safety systems which detect an object outside the vehicle and inform a driver if the object poses a potential hazard. For example a blind spot detection system (BSD) detects objects in a driver's blind spot and alerts the driver to the presence of the object. Another safety system is a rear, cross-traffic alert system (RCTA). The system detects objects approaching, from the sides, the rear of the vehicle, and warns the driver. The RCTA helps a driver by detecting an approaching object when the driver is backing out of a parking space and the driver's vision is blocked. Each safety system is autonomous, using individual detection systems and driver warning systems.

### SUMMARY

The invention integrates a plurality of safety systems into a single autonomous system resulting in a reduction in the number of components. This reduction in the number of components reduces the amount of energy consumed by the safety system as well as the cost of the safety system.

In one embodiment, the invention provides a system for detecting a potential threat to a vehicle, and generating a warning for a driver of the vehicle of the potential threat. The system includes an object detection device, a controller, and a human-machine interface (HMI). The object detection device is configured to detect objects next to the vehicle, approaching the vehicle from a side, and approaching the vehicle from behind. The controller receives an indication of a detected object from the object detection device, and uses a position, a speed, an acceleration, and a direction of travel of the detected object to categorize the detected object as a potential threat when at least one of (a) the vehicle is moving forward and the detected object is adjacent the vehicle, (b) the vehicle is moving forward at a first speed and the detected object is approaching the vehicle from behind at a second speed relative to the first speed that indicates a time to collision is less than a predetermined threshold, and (c) the vehicle is moving in reverse and the detected object is approaching the vehicle from the side, is within a first distance of the vehicle, and is traveling within a range of speeds. The HMI is coupled to the controller and is configured to receive an indication of the potential threat from the controller and to provide the warning to the driver of the potential threat.

The invention also provides a vehicle which includes an object detection device, a controller, and an HMI. The object detection device is configured to detect objects next to the vehicle, approaching the vehicle from a side, and approaching the vehicle from behind. The controller receives an indication of a detected object from the object detection device, and determines a position, a speed, an acceleration, and a direction of travel of the detected object. The controller performs a blind spot detection function, a closing vehicle warning function, and a rear, cross-traffic alert function. The HMI is coupled to the controller and is configured to provide a warning to a driver when the controller determines a potential threat exists.

A method of warning a driver of a vehicle, by a single controller and an object detection device, of a potential threat is also provided by the invention. The method detects an object by the object detection device, determines a position of the object relative to the vehicle, determines a direction of travel of the object, determines a speed of the object relative to a speed of the vehicle, determines an acceleration of the object relative to an acceleration of the vehicle, and determines, by a controller, if the object is in a zone of danger. The zone of danger includes a first area adjacent the vehicle, a second area extending perpendicular from the rear of the vehicle, and a third area extending a distance from the back of the vehicle. The controller determines a time to collision for the detected object in the zone of danger, determines a potential threat exists when at least one of the detected object is in the zone of danger adjacent the vehicle or the time to collision is less than a threshold, and provides an indication of the potential threat to the driver.

Other aspects of the invention will become apparent by consideration of the detailed description and accompanying drawings.

### BRIEF DESCRIPTION OF THE DRAWINGS

FIG. 1 is a schematic drawing of a vehicle incorporating an embodiment of the invention.

FIG. 2 shows positions of vehicles detected by a blind spot detection function and a closing vehicle warning function.

FIG. 3 shows exemplary zones of danger for a blind spot detection function and a closing vehicle warning function.

FIGS. 4A and 4B show positions of vehicles detected by a rear crossing traffic alert function.

FIGS. 5A-5C shows an embodiment of the operation of a system incorporating a blind spot detection function, a closing vehicle warning function, and a rear, cross-traffic alert function.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

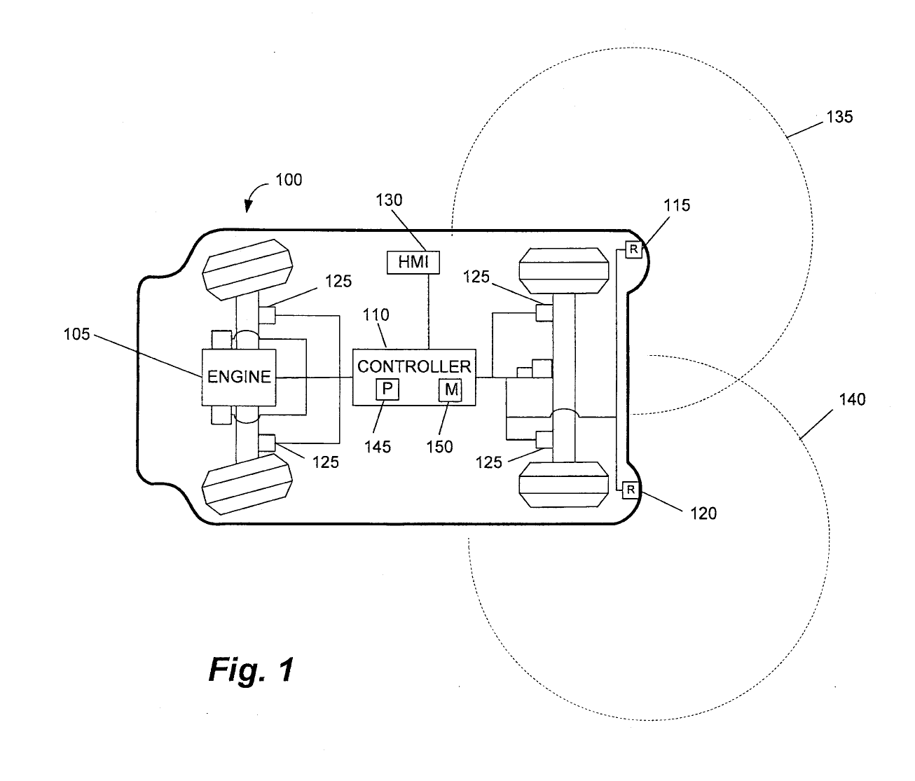

FIG. 1 shows a vehicle 100 incorporating an embodiment of a system which combines lane change assist (LCA) functions (e.g., blind spot detection and closing vehicle warning functions) with rear, cross-traffic alert (RCTA) functions. The vehicle includes an engine 105, a controller 110, a first object detection device 115, a second object detection device 120, a plurality of wheel speed sensors 125, and a human-machine interface (HMI) 130. The controller 110 can be a stand-alone controller (i.e., performing LCA, RCTA, and similar functions) or can incorporate other control functions (e.g., engine control, braking control, etc.). The first and second object detection devices 115 and 120 can be radars, light detecting and ranging (LIDAR) sensors, video cameras, etc. Embodiments of the invention are described herein using mid-range radar sensors (e.g., 24 GHz or 77 GHz) as the object detection devices 115 and 120.

The first and second detection devices 115 and 120 detect objects that are within their field of view (FOV), labeled with reference number 135 and 140, respectively, in FIG. 1. The first and second detection devices 115 and 120 detect where an object is within the FOV 135 or 140 (e.g., using a time-of-flight method), how fast and in what direction the object is moving, and an acceleration of the object (e.g., using Doppler effects). In some embodiments, the first and second object detection devices 115 and 120 communicate the location and motion (e.g., speed, acceleration, and direction) information of objects they detect to the controller 110. In other embodiments, the first and second object detection devices 115 and 120 communicate raw data (e.g., transmitted and received frequencies, time-of-flight, etc.) to the controller 110 and the controller 110 determines one or more of the location, speed, acceleration, and direction of detected objects. In some embodiments, the controller 110 merges the data from the first and second detection devices 115 and 120 together. In other embodiments, one of the first and second detection devices 115 and 120 merges the data from the first and second detection devices 115 and 120 together and communicates the merged data to the controller 110.

The controller 110 includes a processor 145 (e.g., a microprocessor, microcontroller, ASIC, DSP, etc.) and memory 150 (e.g., flash, ROM, RAM, EEPROM, etc.), which can be internal to the processor 145, external to the processor 145, or a combination thereof. The controller 110 also includes other circuits such as input/output circuits and communication circuits. The controller 110 can store information on detected objects in the memory 150 and track the movement of the objects over time.

The HMI 130 provides an interface between the system and a driver. The HMI 130 enables the driver to deactivate one or more of the functions of the system (e.g., the LCA function and/or the RCTA function). The HMI 130 provides a suitable input method such as a button, a touch-screen display having menu options, voice recognition, etc. for turning on/off each function. The HMI 130 also provides warnings to the driver of other vehicles that may pose a potential risk. The HMI 130 provides the warning using a suitable indicator such as a tell-tale light on an instrument cluster, a mirror, a heads-up display, etc., an acoustic alarm such as a chime or buzzer, and/or a haptic indicator (e.g., vibrating the steering wheel). The system can provide different warnings based on a level of the potential risk. For example, the system can light an LED when a vehicle is located in the host vehicle's blind spot. When the system detects that the driver is steering the host vehicle toward the lane in which the vehicle in the blind spot is traveling, the system can provide an acoustic and/or haptic warning in addition to the previously lit LED.

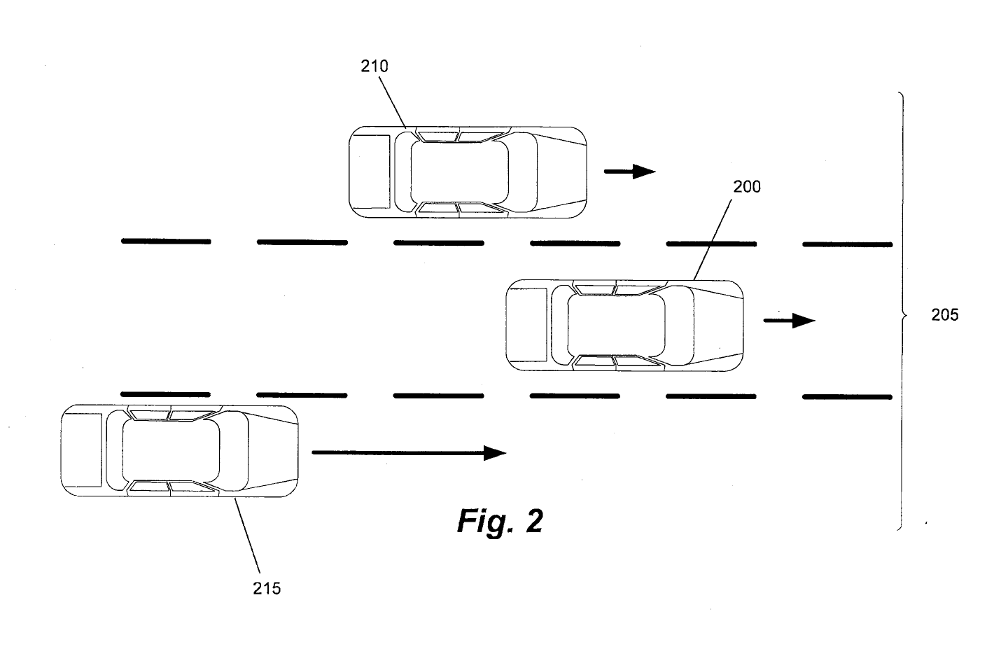

An LCA system includes a blind spot detection function and a closing vehicle warning function. FIG. 2 depicts vehicles that the LCA system warns a driver about. A vehicle 200 is traveling down a three-lane highway 205. A second vehicle 210 is in the driver's blind spot where the driver may not be able to see the vehicle 210 (e.g., via a mirror or the driver's peripheral vision). The LCA system detects the presence of the vehicle 210 in a blind spot area and provides a warning to the driver that the vehicle 210 is in the blind spot area. In some embodiments, the LCA provides a visual indication (e.g., lighting an icon in a side-view mirror) to indicate the presence of the vehicle 210 in the blind spot. The LCA can also use information such as steering wheel angle, yaw rate, etc. to detect a lane change intention of the host vehicle 200 towards the lane where the vehicle 210 is driving. In such a situation, the LCA system can provide an additional warning (e.g., acoustic or haptic) to the driver.

A second vehicle 215 is depicted traveling a distance behind vehicle 200. The LCA detects the vehicle 215 and determines whether the vehicle 215 is closing in on the vehicle 200 such that, were vehicle 200 to move into the lane to its right (i.e., where vehicle 215 is traveling), vehicle 215 would likely collide with vehicle 200. The LCA makes this determination based on the distance the vehicle 215 is from the vehicle 200, and how fast the vehicle 215 is moving relative to the vehicle 200.

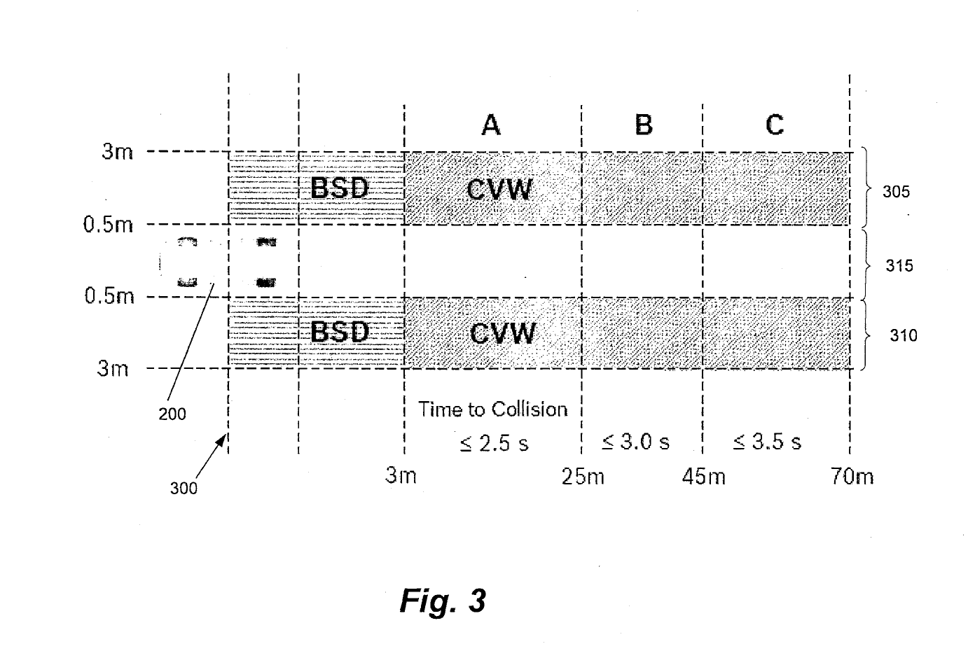

FIG. 3 shows an embodiment of the operating parameters for an LCA function. The blind spot detection function provides a warning to the driver whenever an object (e.g., a vehicle) is adjacent the vehicle 200 (e.g., within an area bounded by a middle 300 of the vehicle 200 to about 3 meters behind the vehicle 200 and from about 0.5 meters to the left and right of the vehicle 200 to about 3 meters left and right, respectively, of the vehicle 200).

The LCA function is implemented using one of the three different configurations using one of three different zones of danger A, B, and C, respectively, as shown in FIG. 3. Exemplary configurations are defined in ISO/DIS 17387 Intelligent transport systems—Lane change decision aid systems—Performance requirements and test procedures, version 2008. Each configuration includes a common BSD area. Each zone (A, B and C) covers a different area in a lane 305 and a lane 310 adjacent to a lane 315 that vehicle 200 is presently in. Specifically, the area covered by zone A extends from about 3 meters to about 25 meters behind the vehicle 200, the area covered by zone B extends from about 3 meters to about 45 meters behind the vehicle 200, and the area covered by zone C extends from about 3 meters to about 70 meters behind the vehicle 200. For each LCA zone, a different time to collision (TTC) threshold is used. All zones A, B (which includes zone A), and C (which includes zones A and B) are bounded by an area about 0.5 meters from the side of the vehicle 200 to about 3 meters from the side of the vehicle 200. The LCA configuration using zone A provides a warning to the driver when the speed of a vehicle in zone A, relative to the host vehicle 200, indicates that a collision will occur in about 2.5 seconds or less (a time to collision). For the LCA configuration using zone B, a warning is given to the driver when the speed of a vehicle in zone B indicates the time to collision is about 3.0 seconds or less. For the LCA configuration using zone C, a warning is given to the driver when a vehicle in zone C indicates the time to collision is about 3.5 seconds or less.

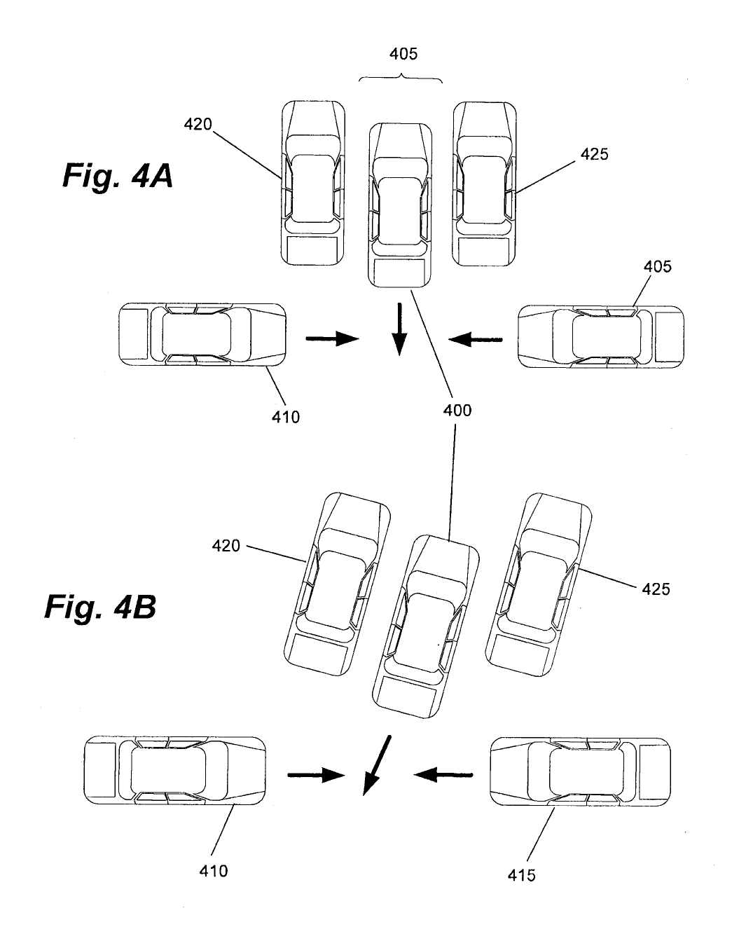

FIGS. 4A and 4B depict vehicles that pose a potential threat and that an RCTA system warns a driver about. In FIG. 4A, a vehicle 400 is backing out of a parking space 405. The driver of the vehicle 400 is unable to see vehicles 410 and 415 approaching from the sides (e.g., perpendicular) because the driver's vision is blocked by other parked vehicles 420 and 425. The RCTA system detects vehicles 410 and 415 and provides a warning to the driver, enabling the driver to stop the vehicle 400 and avoid a collision. FIG. 4B is similar to FIG. 4A except that the parking space is an angled parking space. In some embodiments, the RCTA is able to detect approaching vehicles 410 and 415 when the vehicle 400 is parked on an angle (e.g., up to 60 degrees) as well as when the vehicle 400 is parked perpendicular as shown in FIG. 4A. In addition, in some embodiments, the RCTA can detect approaching vehicles 410 and 415 when the vehicle 400 is parked on a curve or incline (e.g., up to 6 degrees).

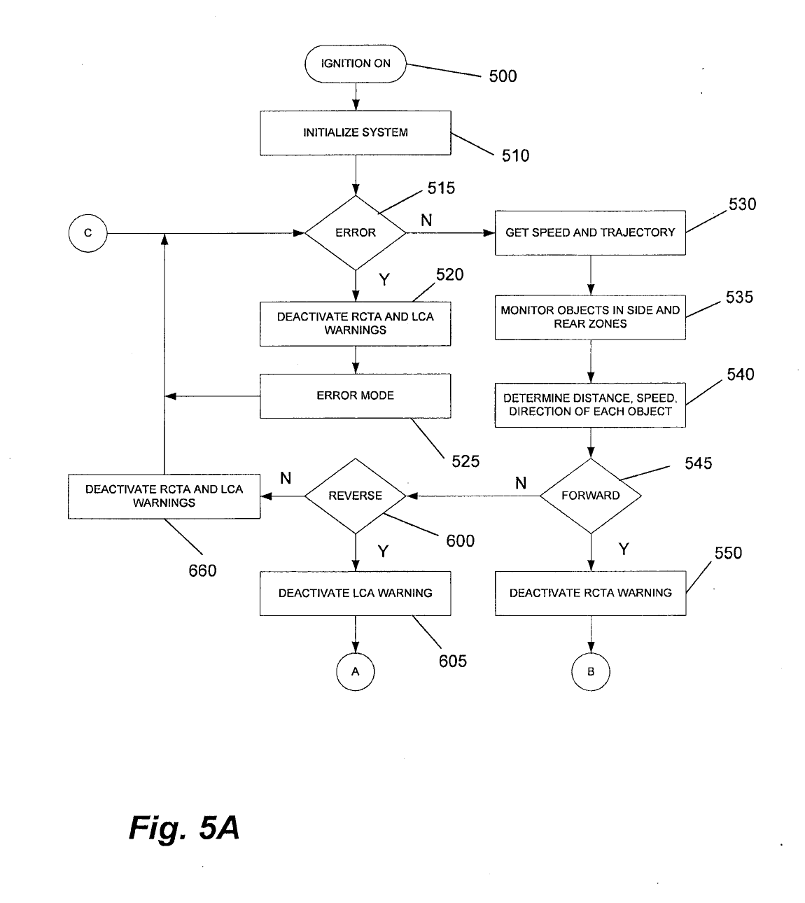

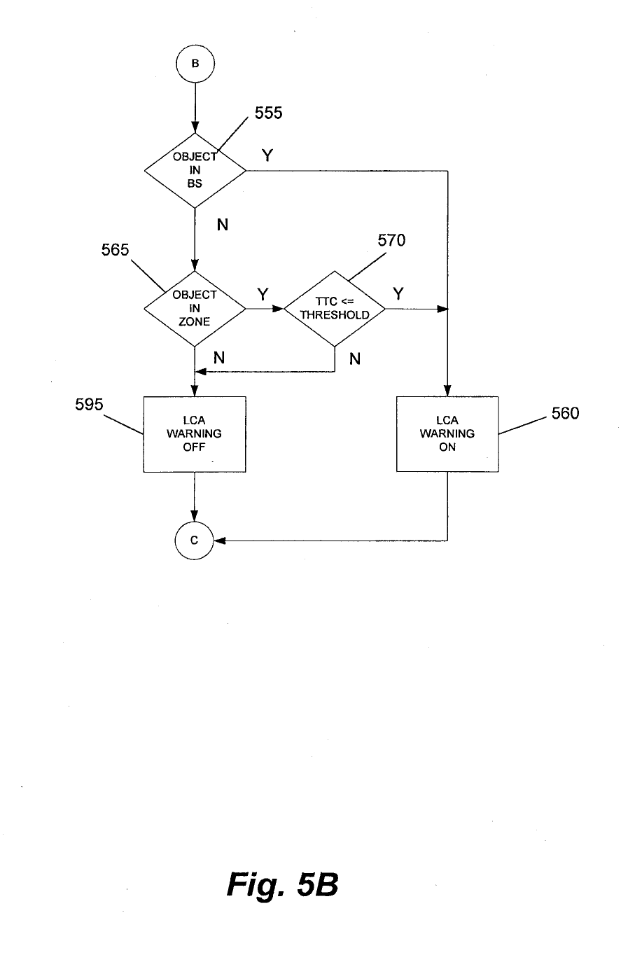

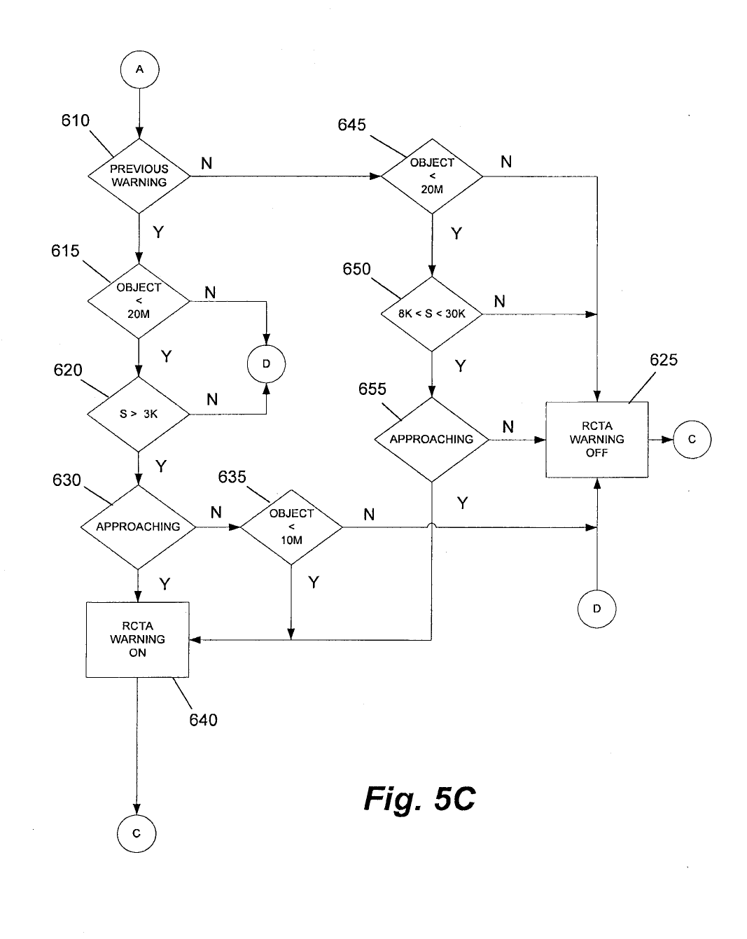

FIGS. 5A to 5C illustrate the operation of an embodiment of a system combining LCA and RCTA functions. The system starts when the ignition of the vehicle is turned on (step 505). The controller 110 then initializes the system (step 510). Initializing the system includes clearing the memory 150 of information from previous operation, and starting the object detection devices 115 and 120. In some embodiments, the LCA and RCTA functions are enabled each time the system is restarted. In other embodiments, if the LCA and/or RCTA functions were previously disabled (e.g., by the driver using the HMI 130), they remain disabled when the system is restarted.

Next the controller 110 checks for an error in the system (step 515). Errors can include faulty sensors, etc. If the controller 110 detects an error, the controller 110 deactivates any LCA or RCTA warnings that are active (step 520) and performs error functions (step 525) (e.g., informing a driver of error conditions and checking faulty sensors to determine if they are functioning properly again). The controller 110 then loops back to recheck if an error exists (step 515).

If there were no errors at step 515, the controller 110 determines the speed and trajectory of the host vehicle (step 530). The controller 110 uses various inputs and sensors to determine the speed and trajectory of the host vehicle. For example, a sensor can detect what gear a transmission of the host vehicle is in or the transmission can provide an indication of the gear (e.g., via a controller area network—CAN). The controller 110 can also receive an indication of the speed and direction of the host vehicle from wheel speed sensors 125. The use of the wheel speed sensors 125 to determine direction can be important for a manual transmission vehicle which may travel in a direction different than indicated by which gear the transmission is in (e.g., rolling backwards because the clutch is engaged when in a forward gear). An engine control module can also communicate the speed of the host vehicle to the controller.

The controller 110 then obtains information on objects around the host vehicle from first and second object detection devices 115 and 120 (step 535), and determines a position, speed, acceleration, and direction of each object (step 540). The position, speed, acceleration, and direction of each object are relative to the speed and trajectory of the host vehicle. In some embodiments, the first and second object detection devices 115 and 120 provide the position, speed, acceleration, and direction of detected objects to the controller 110. In other embodiments, the controller 110 determines one or more of the position, speed, acceleration, and direction of the objects based on data received from the first and second object detection devices 115 and 120.

Next the controller 110 determines whether the host vehicle is moving in a forward direction (step 545). As discussed above, the determination can be based on a detected gear, a wheel speed, or other method (e.g., an accelerometer). If the host vehicle is moving in a forward direction, the controller 110 deactivates any active RCTA warnings (step 550). In some embodiments, the RCTA functions only operate when the vehicle is traveling backward.

Next, the controller 110 determines if an object (e.g., a vehicle) is in the host vehicle's blind spot (step 555, FIG. 5B). If a vehicle is in one of the blind spots, the controller 110 turns a warning on (step 560), and the operation loops back to check for errors (step 515). If there is no vehicle in the blind spots, the controller 110 checks if a vehicle is in a closing vehicle warning (CVW) zone of danger for the implemented CVW configuration (step 565). If a vehicle is a zone of danger for the implemented configuration, the controller 110 determines if a potential threat exists using the speed and acceleration of the vehicle, relative to the speed and acceleration of the host vehicle. If a time to collision (TTC) is equal to or is below a certain threshold (e.g., about 2.5 seconds for zone A, about 3.0 seconds for zone B, and about 3.5 seconds for zone C), the controller 110 determines that a potential threat exists (step 570). If a potential threat exists, the controller 110 turns the warning on (step 560), and the operation loops back to check for errors (step 515).

If at step 565 there was no object in the zone of danger or at step 570 an object in the zone of danger was not approaching fast enough to be considered a potential threat, the controller 110 turns the LCA warning off (step 595) and the operation loops back to check for errors (step 515).

If at step 545, the controller 110 determines that the host vehicle is not traveling forward, the controller 110 checks if the vehicle is traveling backward (step 600). If the host vehicle is moving in a backward direction, the controller 110 deactivates any active LCA warnings (step 605). In this embodiment, LCA functions only operate when the vehicle is traveling forward. In some embodiments, the LCA functions only operate when the host vehicle speed exceeds a minimum threshold (e.g., 30 kph). In some embodiments, one or more LCA functions (e.g., blind spot detection) may continue to operate even when the vehicle is traveling backward.

Next, the controller 110 determines if a RCTA warning already if turned on (step 610, FIG. 5C). If the warning is turned on, the controller 110 determines if the potential threat still exists. First, the controller 110 determines if the detected vehicle is within about 20 meters of the host vehicle (step 615). If the detected vehicle is within a predetermined distance (e.g., about 20 meters), the controller 110 checks if the speed of the detected vehicle is greater than a threshold (e.g., about 3 kph) (step 620). If the detected vehicle is greater than the predetermined distance away from the host vehicle or is traveling at less than about 3 kph, the detected vehicle is not considered to be a potential threat by the controller 110, and the controller 110 turns the warning off (step 625) and loops back to check for errors (step 515).

If after step 620, the vehicle still constitutes a potential threat, the controller 110 determines if the detected vehicle is approaching the host vehicle or moving away from the host vehicle (step 630). If the detected vehicle is moving away from the host vehicle, the controller 110 assesses whether the detected vehicle is still within about 10 meters of the host vehicle (step 635). If the detected vehicle is approaching the host vehicle or the detected vehicle is within about 10 meters of the host vehicle, the controller turns the RCTA warning on (step 640), and continues the operation with checking for error conditions (step 515). If the detected vehicle is moving away from the host vehicle and is more than about 10 meters away from the host vehicle, the detected vehicle is not considered to be a potential threat, and the controller 110 turns the RCTA warning off (step 625), looping back to check for errors (step 515).

If the RCTA warning was not turned on (step 610), the controller 110 checks if a potential threat has appeared. First, the controller 110 checks if an object is within about 20 meters of the host vehicle (step 645). If there is an object within about 20 meters, the controller 110 checks if the object is moving within a range of speeds (e.g., between about 7 and about 35 kph) (step 650). If the object is moving within the speed range, the controller determines if the object is approaching the host vehicle (step 655). If the object is approaching the host vehicle, the controller 110 considers the object to be a potential threat, and turns the RCTA warning on (step 640) and continues operation with checking for error conditions (step 515). If at any of steps 645, 650, and 655, the controller 110 determines that a potential threat does not exist, the controller 110 turns the RCTA warning off (step 625) and continues operation with checking for errors (step 515). In some embodiments, the RCTA warning is issued on a time to collision (TTC) basis. For instance, the RCTA warning is activated if an object is within a certain distance (e.g., less than about 30 meters) of the host vehicle, and is approaching the host vehicle at a speed such that the TTC is less than a threshold (e.g., about 2.5 seconds).

If at step 600 (FIG. 5A), the controller 110 determines that the host vehicle is not traveling backward (e.g., the vehicle is stopped or parked), the controller deactivates any active LCA and RCTA warnings (step 660), and loops back to check for an error condition (step 515). In some embodiments, the controller 110 continues to execute one or more LCA and RCTA functions even though the vehicle is not moving, activating the appropriate warnings. In some embodiments, the controller 110 determines whether the vehicle was previously moving (e.g., it has just recently come to a stop) and maintains appropriate warnings for a time period. For example, a vehicle in which a blind spot detection warning is active, may maintain the blind spot warning for a period of time (e.g., twenty seconds) after coming to a stop. This allows the warning to continue while the vehicle is at a stop.

Thus, the invention provides, among other things, a system combining LCA and RCTA functionality. Various features and advantages of the invention are set forth in the following claims.

What is claimed is:

1. A system for detecting a potential threat to a vehicle and generating a warning to a driver of the vehicle of the potential threat, the system comprising:
an object detection device configured to detect objects next to the vehicle, approaching the vehicle from a side, and approaching the vehicle from behind;
a controller receiving an indication of a detected object from the object detection device, the controller using a position, a speed, an acceleration, and a direction of travel of the detected object to categorize the detected object as a potential threat when at least one of
a) the vehicle is moving forward and the detected object is adjacent the vehicle,
b) the vehicle is moving forward at a first speed and the detected object is approaching the vehicle from behind at a second speed relative to the first speed that indicates a time to collision is less than a predetermined threshold, and
c) the vehicle is moving in reverse and the detected object is approaching the vehicle from the side, is within a first distance of the vehicle, and is traveling within a range of speeds; and
a human-machine interface (HMI) coupled to the controller and configured to receive an indication of the potential threat from the controller and to provide a warning to the driver of the potential threat.

2. The system of claim 1, wherein the controller receives the position, the speed, the acceleration, and the direction of travel of the detected object from the object detection device.

3. The system of claim 1, wherein the controller receives the indication of the position of the detected object from the object detection device, and determines the speed, the acceleration, and the direction of travel of the detected object using the position and one or more positions of the detected object stored in a memory of the controller.

4. The system of claim 1, further comprising a wheel speed sensor, the controller determining the direction of travel of the vehicle based on a wheel speed indication received from the wheel speed sensor.

5. The system of claim 1, wherein the controller categorizes the detected object as a potential threat when the detected object is between about 3 meters and a predetermined maximum distance behind the vehicle and the time to collision is less than a predetermined time threshold.

6. The system of claim 5, wherein the predetermined maximum distance and predetermined time are at least one of about 25 meters and about 2.5 seconds, about 45 meters and about 3.0 seconds, and about 70 meters and about 3.5 seconds.

7. The system of claim 1, wherein the controller categorizes the detected object as a potential threat when the first distance is less than about 20 meters, the speed range is greater than about 7 kilometers per hour (kph) and less than about 35 kph, and the detected object is approaching the vehicle.

8. The system of claim 1, wherein the controller categorizes the detected object as a potential threat when the controller has previously categorized the detected object as a potential threat and where the vehicle is moving in reverse, the detected object is less than about 20 meters from the vehicle, the detected object is traveling at greater than about 3 kph, and at least one of the detected object is approaching the vehicle and the detected object is less than about 10 meters from the vehicle.

9. The system of claim 1, wherein the HMI provides a first warning when the detected object is adjacent the vehicle, and the HMI provides a second warning when the controller determines the vehicle is moving toward the detected object adjacent the vehicle.

10. A vehicle, comprising:
an object detection device configured to detect objects next to the vehicle, approaching the vehicle from a side, and approaching the vehicle from behind;
a controller receiving an indication of a detected object from the object detection device, the controller determining a position, a speed, an acceleration, and a direction of travel of the detected object and performing a blind spot detection function, a closing vehicle warning function, and a rear, cross-traffic alert function; and
a human-machine interface (HMI) coupled to the controller and configured to provide a warning to a driver when the controller determines a potential threat exists.

11. The vehicle of claim 10, wherein
the blind spot detection function determines a potential threat exists when the vehicle is moving forward and the detected object is adjacent the vehicle;
the closing vehicle warning function determines a potential threat exists when the vehicle is moving forward at a first speed and the detected object is approaching the vehicle from behind at a second speed, relative to the first speed, that indicates a time to collision is less than a threshold, and
the rear, cross-traffic alert function determines a potential threat exists when the vehicle is moving in reverse and the detected object is approaching the vehicle from the side, the detected object within a first distance and traveling within a speed range;

12. The vehicle of claim 11, further comprising a wheel speed sensor, the controller determining a direction of movement of the vehicle based on a wheel speed indication received from the wheel speed sensor.

13. A method for warning a driver of a vehicle, by a single controller and an object detection device, of a potential threat, the method comprising:
detecting an object by the object detection device;
determining a position of the object relative to the vehicle;
determining a direction of travel of the object;
determining a speed of the object relative to a speed of the vehicle;
determining an acceleration of the object relative to an acceleration of the vehicle;
determining, by a controller, if the object is in a of zone of danger, the zone of danger including a first area adjacent the vehicle, a second area extending perpendicular from the rear of the vehicle, and a third area extending a distance from the back of the vehicle;
determining a time to collision for the detected object in the zone of danger;
categorizing the detected object as a potential threat when at least one of the detected object is in the zone of danger adjacent the vehicle and the time to collision is less than a threshold; and
providing an indication of the potential threat to the driver.

14. The method of claim 13, further comprising receiving at the controller, from the object detection device, the position of the object relative to the vehicle, the direction of travel of the object, the acceleration of the object, and the speed of the object relative to the vehicle.

15. The method of claim 13, further comprising determining a direction of movement of the vehicle.

16. The method of claim 15, wherein when the vehicle is moving forward and the controller categorizes the detected object as a potential threat when the detected object is at least one of
between about 3 meters and about 25 meters behind the vehicle and the time to collision is less than about 2.5 seconds,
between about 3 meters and about 45 meters behind the vehicle and the time to collision is less than about 3.0 seconds, and
between about 3 meters and about 70 meters behind the vehicle and the time to collision is less than about 3.5 seconds.

17. The method of claim 15, wherein when the vehicle is moving backward and the controller categorizes the detected object as a potential threat when a first distance between the vehicle and the detected object is less than about 20 meters, a speed range of the detected object is greater than about 7 kilometers per hour (kph) and less than about 35 kph, and the detected object is approaching the vehicle.

18. The method of claim 15, wherein when the vehicle is moving backward and the controller categorizes the detected object as a potential threat when the controller has previously categorized the detected object as a potential threat, and where the detected object is less than about 20 meters from the vehicle, the object is traveling at greater than about 3 kph, and at least one of the detected object is approaching the vehicle and the detected object is less than about 10 meters from the vehicle.

19. The method of claim 13, wherein the indication of the potential threat is provided to the driver via a human machine interface using at least one of a visual indication, an acoustical indication, and a haptic indication.

20. The method of claim 13, wherein the indication of the potential threat is provided to the driver by two or more visual, acoustic, and haptic indications.
